(19) United States
(12) Patent Application Publication
(10) Pub. No.: US 2007/0252931 A1
(43) Pub. Date: Nov. 1, 2007

(54) Transflective liquid crystal display device

(75) Inventors: Yi-Chun Wu, Hualien City (TW); Chin-Chang Liu, Taichung County (TW); Wen-Jui Liao, Taichung County (TW); Chun-Chi Chi, Taichung County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/414,220

(22) Filed: May 1, 2006

(51) Int. Cl. G02F 1/1335

(52) U.S. Cl. 349/114; 349/117

(57) ABSTRACT

A transflective liquid crystal display device mainly includes a single-cell gap panel, and the bottom surface of the single-cell gap panel has a reflective device. A first liquid crystal (LC) film is installed at the top side of the single-cell gap panel, and a first polarizer is equipped at the top side of the first LC film, a second LC film is equipped at the bottom side of the single-cell gap panel, and a second polarizer is equipped at the bottom side of the second LC film. By way of this optical structure compensation, the present invention which collocates the LC films with the transflective structure of a common single-cell gap panel can complete the transflective optic mode and obtain better reflective contrast ratio, transmissive contrast ratio and higher transmittance for liquid crystal display devices.

### FIELD OF THE INVENTION

The present invention relates to a transflective liquid crystal display device, especially to a transflective optical compensation structure that is formed by collocating a liquid crystal (LC) film to the top/bottom side of the single-cell gap display panel so as to achieve excellent optical characteristics for liquid crystal display panels.

### BACKGROUND OF THE INVENTION

Transmissive-mode liquid crystal display (LCD) devices have the characteristics of high luminance, high contrast and high color saturation. But all light source of the display is offered by the backlight system under the panel such that the power consumption is very high and the displayed image is blurred under the sunlight. The reflective-mode LCDs use the outdoor light to be the light source, and reflect the incident light by the reflective layer under the LC layer such that the backlight module can be omitted. Besides, the reflective LCDs have the characteristics of low power consumption and good outdoor legibility. However, the contrast and color purity of the reflective LCDs are lower than that of the transmissive LCDs, and the reflective LCDs is not recognized as the ambient light is dim.

Consequently, the transflective LCD is developed to solve the drawbacks of the above-mentioned methods. At the present day, the transflective LCD uses the method of the double LC layers (as shown in FIG. 1), which is composed of a semi-reflective layer 13 that is interposed between the first LC layer 11 and the second LC layer 12, and then interposed between the retardation films 14, 15 that are used for optical path compensation, and then two polarizers 16, 17 at the outmost in sequence. The first LC layer 11 is driven to display images. The twisted orientations of the first LC layer 11 and the second LC layer 12 are reversed whereas the retardation values are equal. By way of this combination, the characteristics of zero retardation value due to mutual compensation and high contrast ratio are achieved. However, the thickness of the liquid crystal display device made by this method is too thick, which does not meet the recent market features of light and thin.

As shown in FIG. 2, another structure that designs the cell gap of the reflective area R (d) of the LC layer 21 to be half of the cell gap of the transmissive area T (2d), and a insulating layer 211 is made in the reflective area R and a reflection layer 212 is placed at the surface of the insulating layer 211 such that the optical path differences made in different areas are equal. And two retardation layers 22, 23 that are pasted on the top and bottom sides of the LC layer 21 and are used for optical path compensation, and then two polarizers 24, 25 at the outmost in sequence. As a result, this transflective liquid crystal display devices with dual-cell gap LC layer need to make a insulating layer 211 such that the devices not only have the complicated process of dual-cell gap design for the LC layer but also result in increasing cost and low yield-rate.

### SUMMARY OF THE INVENTION

Consequently, the main purpose of the present invention is to change the structure design of a single-cell gap liquid crystal display, change the whole optical system, and then to compensate the transflective optical characteristic of a single-cell gap LCDs such that both the reflective area and the transmissive area can obtain excellent characteristics such as contrast ratio, etc.

Another purpose of the present invention is that the present invention only changes the rubbing direction angle of a single-cell gap LCDs, and the collocation of the polarizers and LC films, other manufacturing processes are not necessary to be altered. Accordingly, the manufacturing yield-rate can be increased and the thickness and cost of a device can be reduced.

The present invention is a transflective liquid crystal display device, the LCD mainly includes a single-cell gap panel, and the lower surface of the single-cell gap panel has a reflective device. A first LC film is installed at the top side of the single-cell gap panel, and a first polarizer is equipped at the top side of the first LC film. A second LC film is equipped at the bottom side of the single-cell gap panel, and a second polarizer is equipped at the bottom side of the second LC film. The first LC film and the second LC film are polymer LC films or LC molecular layers.

By way of this optical structure compensation, the present invention which collocates the LC films with the transflective structure of a common single-cell gap panel can complete the transflective optic mode and obtain better reflective contrast ratio, transmissive contrast ratio and higher transmittance for liquid crystal display devices.

### BRIEF DESCRIPTION FOR THE DRAWINGS

FIG. 1 is the schematic diagram for the structure of a well-known double-layer liquid crystal display device.

FIG. 2 is the schematic diagram for the structure of a well-known liquid crystal display device with an insulating layer and dual-cell gap design.

FIG. 3 is the schematic diagram for the structure of the first embodiment example of the present invention.

FIG. 4 is the schematic diagram for the structure of the second embodiment example of the present invention.

FIG. 5 is the schematic diagram for the structure of the third embodiment example of the present invention.

FIG. 6 is the schematic diagram for the structure of the fourth embodiment example of the present invention.

FIG. 7 is the schematic diagram for the structure of the fifth embodiment example of the present invention.

FIG. 8 is the schematic diagram for the structure of the sixth embodiment example of the present invention.

FIG. 9 is the schematic diagram for the structure of the seventh embodiment example of the present invention.

FIG. 10 is the schematic diagram for the structure of the eighth embodiment example of the present invention.

FIG. 11 is the schematic diagram for the structure of the ninth embodiment example of the present invention.

FIG. 12 is the schematic diagram for the structure of the tenth embodiment example of the present invention.

FIG. 13 is the schematic diagram for the structure of the eleventh embodiment example of the present invention.

FIG. 14 is the schematic diagram for the structure of the twelfth embodiment example of the present invention.

FIG. 15 is the schematic diagram for the structure of the thirteenth embodiment example of the present invention.

FIG. 16 is the schematic diagram for the structure of the fourteenth embodiment example of the present invention.

FIG. 17 is the diagram for the relation among the reflectance, transmittance, and voltage of the first embodiment example of the present invention.

FIG. 18 is the diagram for the relation among the reflectance, transmittance, and voltage of the eleventh embodiment example of the present invention.

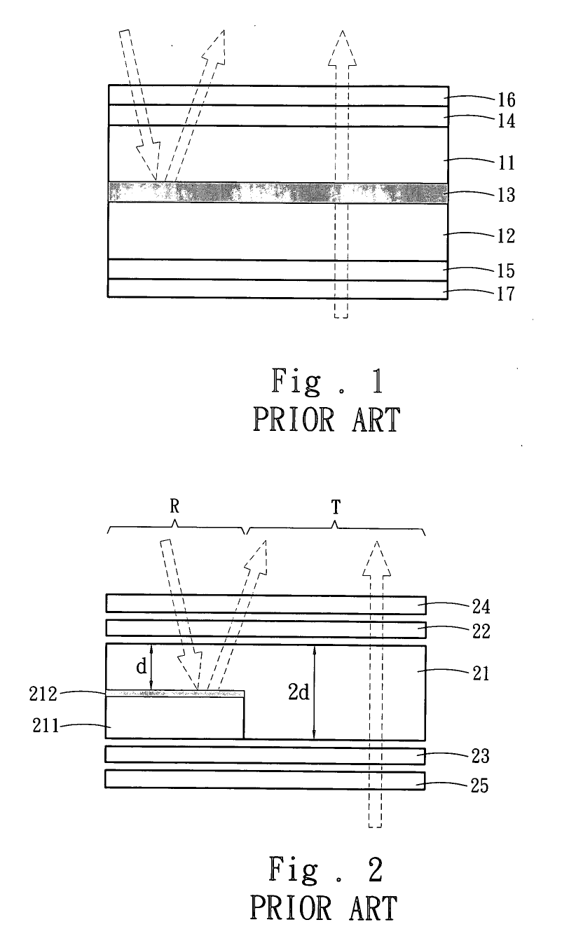

### DETAILED DESCRIPTION OF THE PREFERRED EMBODIMENTS

The detailed descriptions for the content and technology of the present invention associate with figures are as follows.

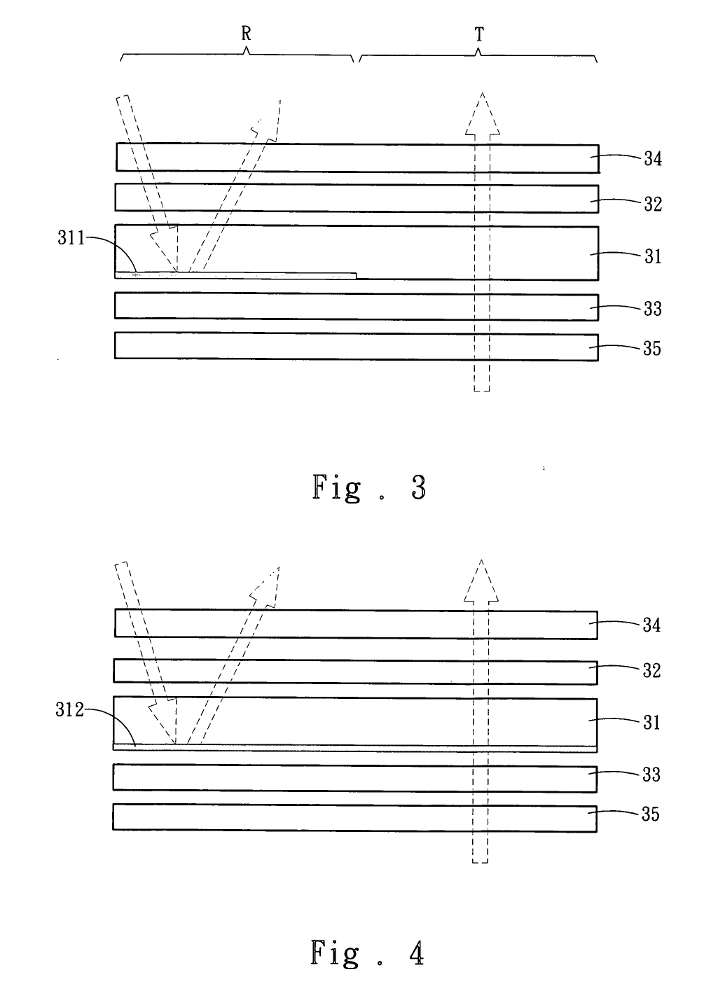

Please refer to FIGS. 3 and 4 together. The present invention is a transflective type liquid crystal display device. The liquid crystal display device mainly includes a single-cell gap panel 31, and the lower surface of the single-cell gap panel 31 has a reflective device. The reflective device is a reflective plate 311 and the reflective plate 311 forms holes, which forms the reflective area R with the reflective plate 311 and the transmissive area T without the reflective plate 311 (as shown in FIG. 3). Or the reflective device also can be a single-layer or multi-layer metal semi-reflective film 312 (as shown in FIG. 4). By way of the semi-transmissive and semi-reflective optical characteristics of the semi-reflective film 312 such that the single-cell gap panel 31 has the transflective characteristics.

Next, a first LC film 32 is installed at the top side of the single-cell gap panel 31, and a first polarizer 34 is equipped at the top side of the first LC film 32. A second LC film 33 is equipped at the bottom side of the single-cell gap panel 31, and a second polarizer 35 is equipped at the bottom side of the second LC film 33. The first LC film 32 and the second LC film 33 are polymer LC films or LC molecular layers.

According to the above-mentioned configuration in FIGS. 3 and 4, the twisted angle of the LC molecule in the single-cell gap panel 31 is between 60°˜90°, and the retardation value of the single-cell gap panel 31 is between 250 nm˜330 nm.

The angle of the transmissive axis of the first polarizer 34 is between 150°˜180°. The retardation value (Δnd) of the first LC film 32 is between 150˜210 nm, the bottom rubbing direction angle is between +30°˜+65° (in accordance with the included angle of the horizontal vision axis, the clockwise direction is “−” and the counterclockwise direction is “+”), and the twisted angle of the LC molecule is between dextrorotary 45°˜75° (dextrorotation represents that the bottom rubbing direction angle makes the LC molecule rotates from down to up counterclockwise).

The angle of the transmissive axis of the second polarizer 35 is between 55°˜85°. The Δnd of the second LC film 33 is between 140˜180 nm, the bottom rubbing direction angle is between −10°˜−40°, and the twisted angle of the LC molecule is between dextrorotary 35°˜65°.

Regarding the action principles, when the voltage of the display device is not applied, the outdoor light (the incident light) of the reflective area R passes through the first LC film 32 and the single-cell gap panel 31, which is equivalent to a ½λ optic path, and then is reflected by the reflective device (as the reflective plate 311 shown in FIG. 3) to generate a reflective light. The reflective light passes through the first LC film 32 and the single-cell gap panel 31 again, which is equivalent to passes through a ½λ optic path again. As a result, the reflective light passes through an λ optic path equivalently so as to become a bright state. And the transmissive area T uses the characteristics of the LC molecule inside the single-cell gap panel 31 in addition to the adequate optical path difference adjusted by the second LC film 33 and the first LC film 32 such that the incident light came out from the backlight can be the most transmittance so as to form a bright state.

On the other hand, when the voltage of the display device is applied, the outdoor light (the incident light) of the reflection area R passes through the first LC film 32 and the single-cell gap panel 31, which is equivalent to a ¼λ optic path, and then is reflected by the reflective device (as the reflective plate 311 shown in FIG. 3) to generate a reflective light. The reflective light passes through the first LC film 32 and the single-cell gap panel 31 again, which is equivalent to passes through a ¼λ optic path again. As a result, the reflective light passes through a ½λ optic path equivalently so as to make the reflection area R to present a dark state. While in the transmissive area T, the incident light came out from the backlight, and the transmissive area T which is collocated the adequate conditions of polarizers (the first polarizer 34 and the second polarizer 35) can present a dark state.

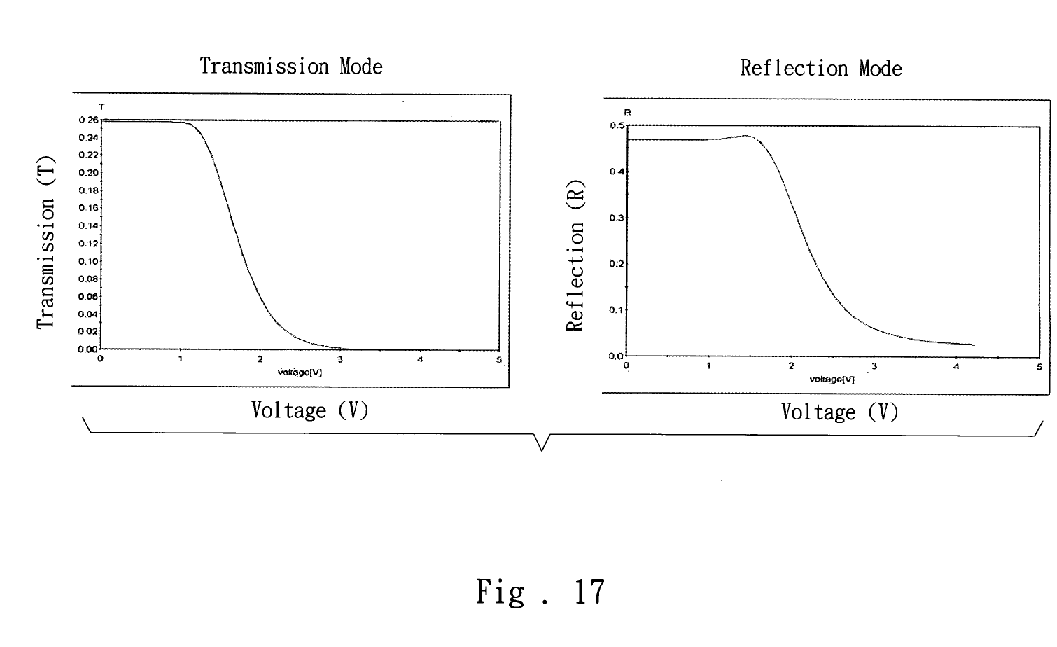

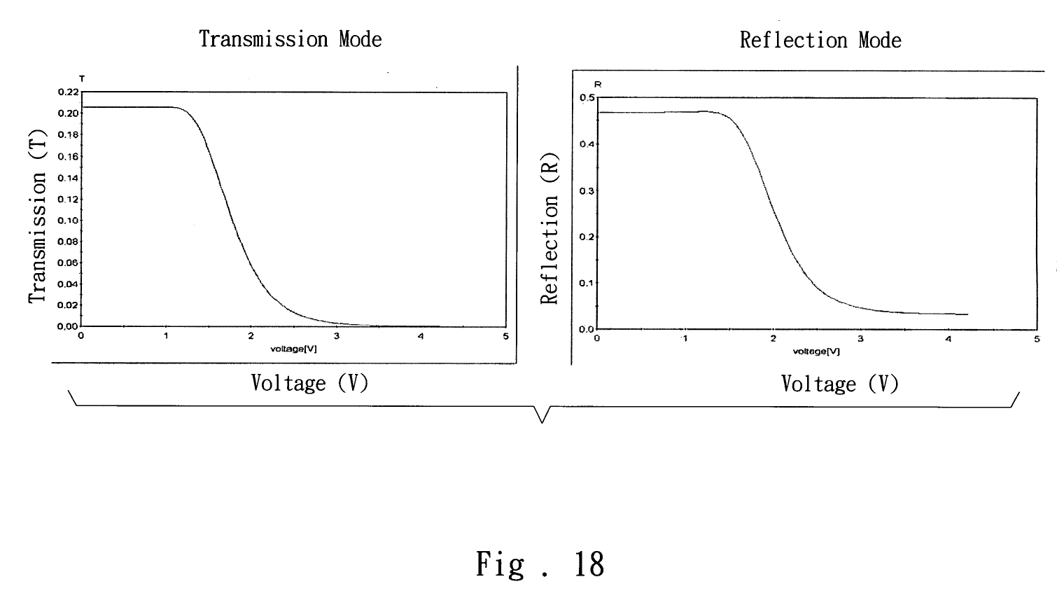

For example as the configuration of FIG. 3, when the structure conditions of the transflective LCD device of present invention are: the bottom rubbing direction angle of the LC molecule inside the single-cell gap panel 31 is −55°, twisted angle is levorotary 70° (levorotation represents that the bottom rubbing direction angle makes the LC molecule rotates from down to up clockwise), the compensation value of the phase difference is 280 nm. The angle of the transmissive axis of the first polarizer 34 is 170°, the retardation value of the first LC film 32 is 180 nm, the bottom rubbing direction angle of the LC molecule is 50°, and the twisted angle is dextrorotary 60°; the retardation value of the second LC film 33 is 160 nm, the bottom rubbing direction angle of the LC molecule is −25°, and the twisted angle is dextrorotary 50°; the angle of the transmissive axis of the second polarizer 35 is 70°. Under these conditions, simulated and verified by the optical simulation software-DIMOS, the transflective LCD device of present invention obtained the results that the reflective contrast ratio is greater than 17 and the transmissive contrast ratio is greater than 745. The characteristics are shown in FIG. 17. Either the reflective mode or the transmissive mode can obtain excellent optical characteristics such as contrast ratio, etc.

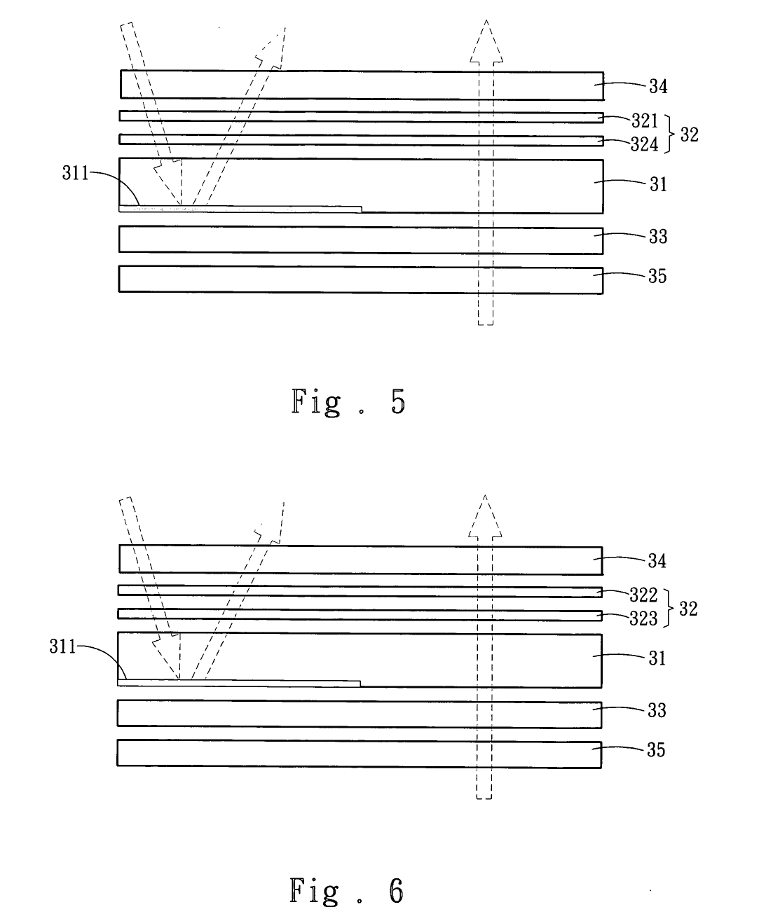

Moreover, the first LC film 32 can further be a combination of anisotropic optic compensation films. As shown in FIG. 5, the first LC film 32 includes a quarter-wave plate 324 and an LC compensation plate 321 which is above the quarter-wave plate 324.

Or, as shown in FIG. 6, the first LC film 32 includes a half-wave plate 322, and the half-wave plate 322 is above an LC compensation plate 323.

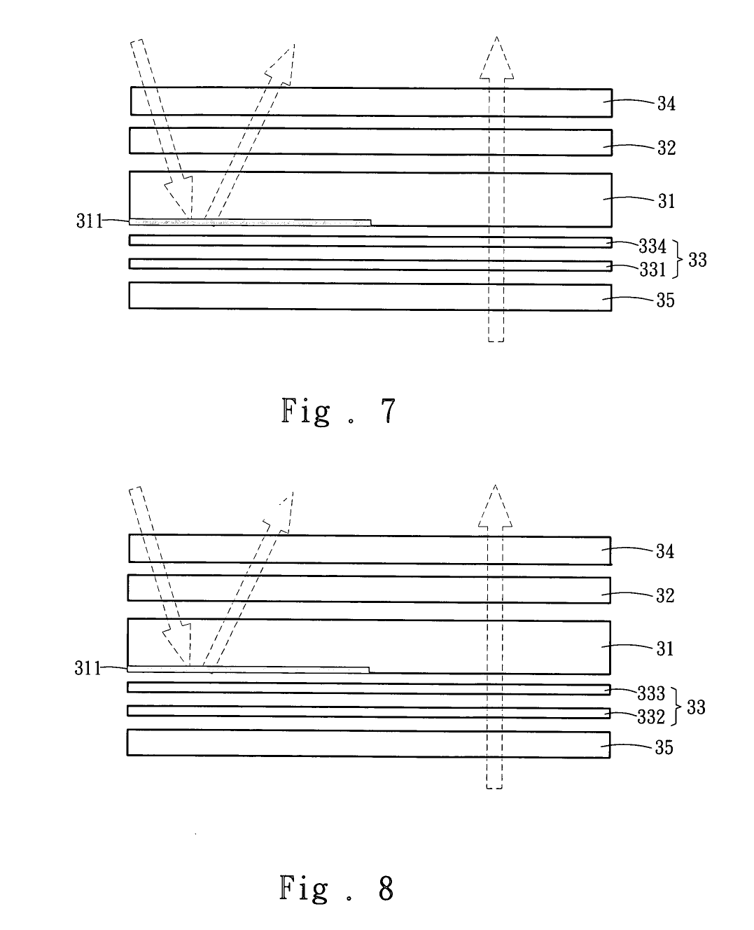

Similarly, the second LC film 33 can further be a combination of anisotropic optic compensation films. As shown in FIG. 7, the second LC film 33 includes a quarter-wave plate 334, and the quarter-wave plate 334 is above an LC compensation plate 331.

Or, as shown in FIG. 8, the second LC film 33 includes a half-wave plate 332, and the half-wave plate 332 is under an LC compensation plate 333.

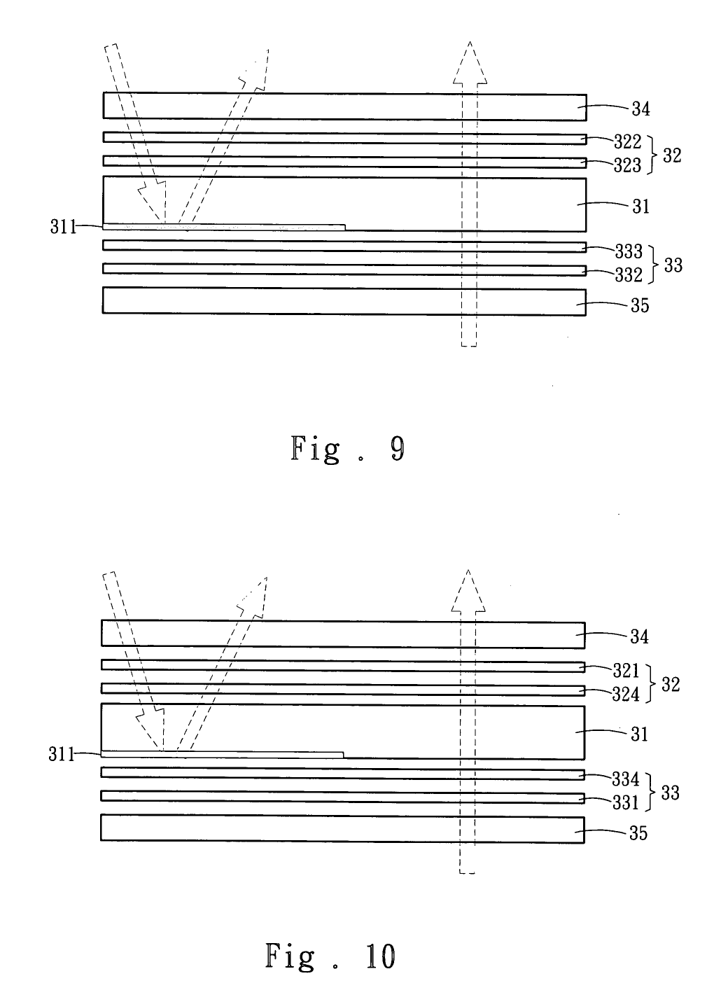

Of course, the anisotropic optic compensation films can be the collocated combination of FIGS. 5˜8. As shown in FIG. 9, the first LC film 32 includes a half-wave plate 322, and the half-wave plate 322 is above the LC compensation plate 323; and the second LC film 33 includes a half-wave plate 332, and the half-wave plate 332 is under the LC compensation plate 333.

Or, as shown in FIG. 10, the first LC film 32 includes a quarter-wave plate 324, and the quarter-wave plate 324 is under the LC compensation plate 321; and the second LC film 33 includes a quarter-wave plate 334, and the quarter-wave plate 334 is above the LC compensation plate 331.

Or, as shown in FIG. 11, the first LC film 32 includes a quarter-wave plate 324, and the quarter-wave plate 324 is under the LC compensation plate 321; and the second LC film 33 includes a half-wave plate 332, and the half-wave plate 332 is under the LC compensation plate 333.

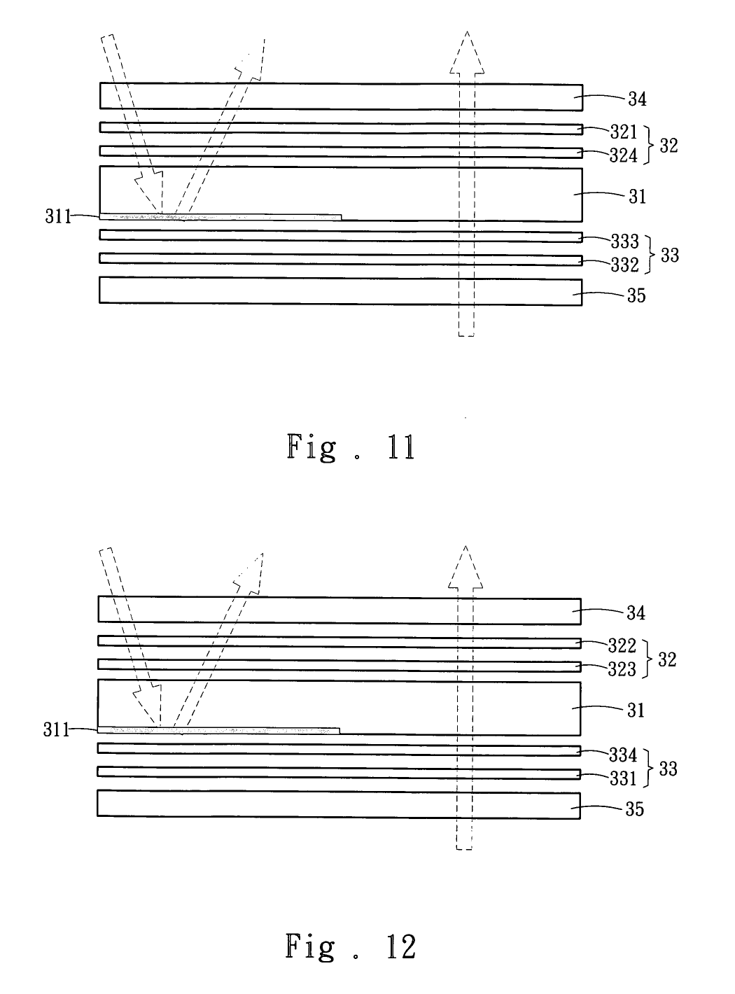

Or, as shown in FIG. 12, the first LC film 32 includes a half-wave plate 322, and the half-wave plate 322 is above the LC compensation plate 323; and the second LC film 33 includes a quarter-wave plate 334, and the quarter-wave plate 334 is above the LC compensation plate 331.

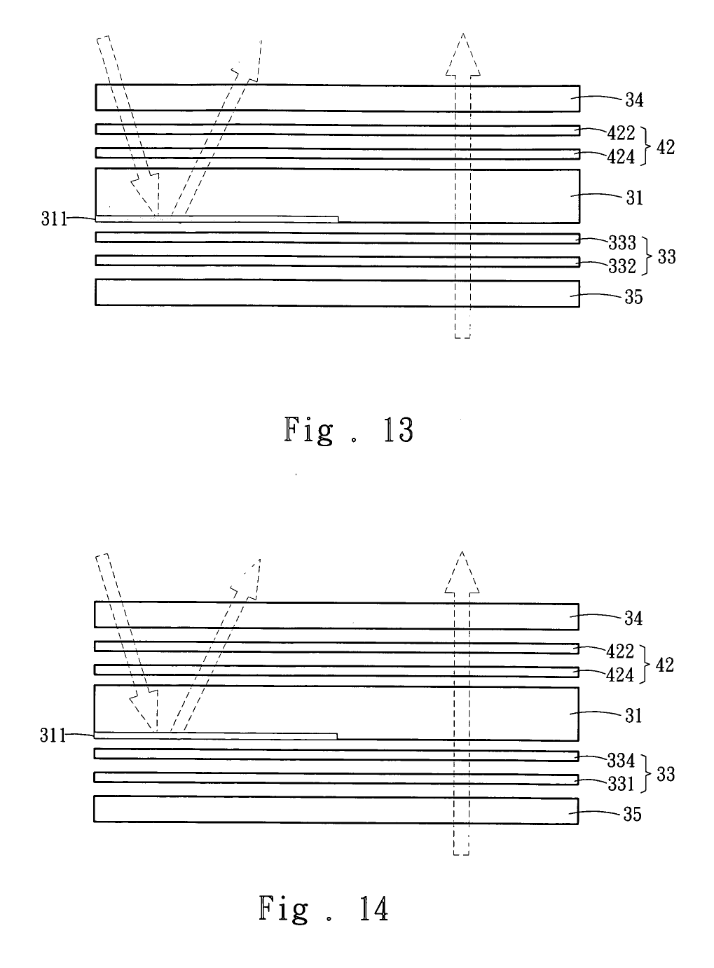

According to optic principles, the first LC film 32 can also be substituted by the upper compensation plate 42 that is composed of the half-wave plate 422 and the quarter-wave plate 424, as shown in FIG. 13. The upper compensation plate 42 is located at the top side of the single-cell gap panel 31, and the first polarizer 34 is located at the top side of the upper compensation plate 42.

At this time, the twisted angle of the LC molecule of the single-cell gap panel 31 is between 60°˜90°, and the retardation value of the single-cell gap panel 31 is 250 nm˜330 nm. The angle of the transmissive axis of the first polarizer 34 is between 65°˜95°. The retardation value (Δnd) of the half-wave plate 422 of the upper compensation plate 42 is between 250˜290 nm, whose slow axis angle is between 50°˜80°; and the retardation value (Δnd) of the quarter-wave plate 424 is between 140˜160 nm, whose slow axis angle is between 0°˜20°. The angle of the transmissive axis of the second polarizer 35 is between 75°˜95°.

Now the second LC film 33 includes the LC compensation plate 333 and the half-wave plate 332 under the LC compensation plate 333 respectively. The retardation value (Δnd) of the LC compensation plate 333 is between 120˜160 nm, the bottom rubbing direction angle is between 0°˜−20°, the twisted angle is between dextrorotary 5°˜35°; and the Δnd of the half-wave plate 332 is between 240˜290 mn, whose slow axis angle is between 60°˜80°.

For example as the configuration of FIG. 13, when the conditions of the transflective type LCDs of present invention are: the bottom rubbing direction angle of the LC molecule inside the single-cell gap panel 31 is −55°, whose twisted angle is levorotary 70°, the compensation value of the phase difference is 280 nm. The angle of the transmissive axis of the first polarizer 34 is 80°, the slow axis angle of the half-wave plate 422 is 65°, the retardation value is 270 nm; and the slow axis angle of the quarter-wave plate 424 is 5°, the retardation value is 140 nm. The retardation value of the LC compensation plate 333 is 148 nm, the bottom rubbing direction angle of the LC molecule is −10°, and the twisted angle is dextrorotary 20°. The slow axis angle of the half-wave plate 332 is 68°, the retardation value is 270 nm; and the angle of the transmissive axis of the second polarizer 35 is 88°. Under these conditions, simulated and verified by the optical simulation software-DIMOS, the transflective type LCDs of present invention obtained the results that the reflective contrast ratio is greater than 13 and the transmissive contrast ratio is greater than 515. The characteristics are shown in FIG. 18. Either the reflective region R or the transmissive region T can obtain excellent characteristics such as contrast ratio, etc.

Besides, the above-mentioned structure also can be the structure as shown in FIG. 14. The second LC film 33 includes the quarter-wave plate 334 and the LC compensation plate 331 under the quarter-wave plate 334 respectively.

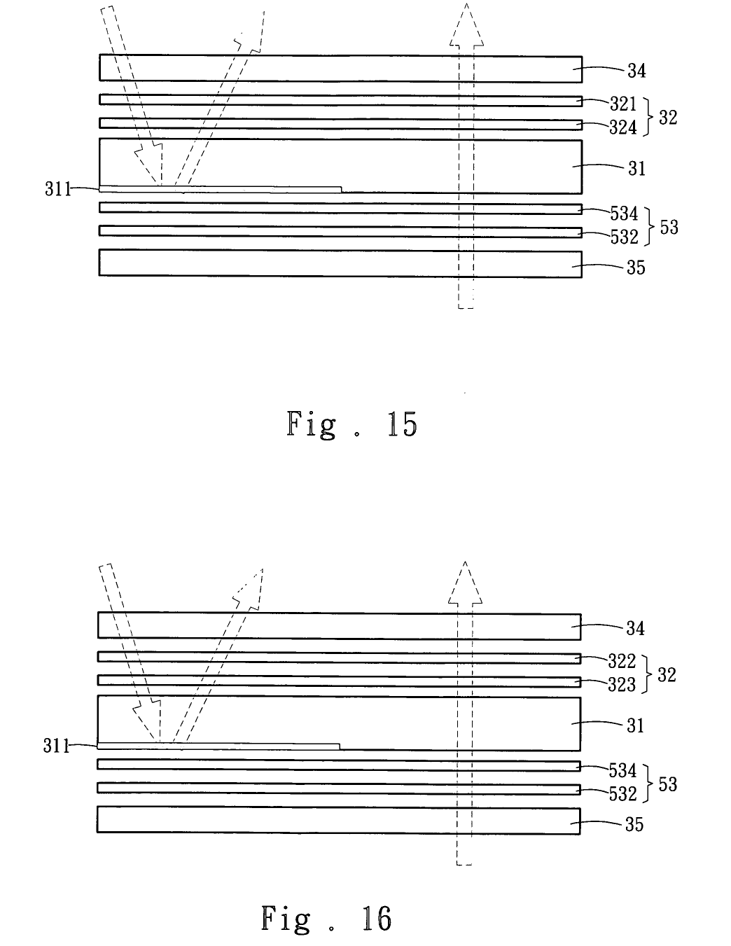

Similarly, the second LC film 33 can also be substituted by the lower compensation plate 53 that is composed of the half-wave plate 532 and the quarter-wave plate 534 as shown in FIG. 15. The lower compensation plate 53 is located at the bottom side of the single-cell gap panel 31, and the second polarizer 35 is located at the bottom side of the lower compensation plate 53.

Certainly, the aforementioned structure also can be the structure as shown in FIG. 16. The first LC film 32 includes the LC compensation plate 323 and the half-wave plate 322 above the LC compensation plate 323 respectively.

To sum up the above-mentioned structure configurations, the present invention uses at least one LC film included in the upper and lower compensation plates to change the optical design of the single-cell gap liquid crystal. By way of the LC film to change the whole optical system, to compensate the transflective optical characteristic of a single-cell gap LC display device such that both the reflective area and the transmissive area can obtain excellent characteristics such as contrast ratio, etc.

Regarding the manufacturing process, the present invention only changes the rubbing direction angle of a single-cell gap LCD and places the polarizers and LC films. The remnant manufacturing processes are not necessary to be altered. Accordingly, the manufacturing yield-rate can be increased and the thickness and cost of a device can be reduced.

However, the above descriptions are only better practice examples for the present invention, which are not used to limit the practice scope of the invention. All equivalent changes and modifications based on the claimed items of present invention are in the scope of the present invention.

What is claimed is:

1. A transflective liquid crystal display device, comprising:
a single-cell gap panel, and the lower surface of the single-cell gap panel having a reflective device;
a first liquid crystal (LC) film, installed at the top side of the single-cell gap panel;
a first polarizer, equipped at the top side of the first LC film;
a second LC film, equipped at the bottom side of the single-cell gap panel; and
a second polarizer, equipped at the bottom side of the second LC film.

2. The transflective liquid crystal display device as claimed in claim 1, wherein the reflective device is a reflective plate with holes that forms a reflective area and a transmissive area.

3. The transflective liquid crystal display device as claimed in claim 1, wherein the reflective device is a metal transflective film.

4. The transflective liquid crystal display device as claimed in claim 1, wherein the first LC film and the second LC film are one of polymer LC films and LC molecular layers.

5. The transflective liquid crystal display device as claimed in claim 1, wherein the LC twisted angle of the single-cell gap panel is between 60°˜90°, and the retardation value of the single-cell gap panel is between 250 nm˜330 nm.

6. The transflective liquid crystal display device as claimed in claim 1, wherein the angle of the transmissive axis of the first polarizer is between 150°˜180°.

7. The transflective liquid crystal display device as claimed in claim 1, wherein the retardation value (Δnd) of the first LC film is between 150˜210 nm, the bottom rubbing direction angle is between +35°˜+65°, and the twisted angle is between dextrorotary 45°˜75°.

8. The transflective liquid crystal display device as claimed in claim 1, wherein the angle of the transmissive axis of the second polarizer is between 55°˜85°.

9. The transflective liquid crystal display device as claimed in claim 1, wherein the retardation value (Δnd) of the second LC film is between 140˜180 nm, the bottom rubbing direction angle is between −10°˜−40°, and the twisted angle is between dextrorotary 35°˜65°.

10. The transflective liquid crystal display device as claimed in claim 1, wherein the first LC film includes a quarter-wave plate, and the quarter-wave plate is under an LC compensation plate.

11. The transflective liquid crystal display device as claimed in claim 1, wherein the first LC film includes a half-wave plate, and the half-wave plate is above an LC compensation plate.

12. The transflective liquid crystal display device as claimed in claim 1, wherein the second LC film further includes a quarter-wave plate, and the quarter-wave plate is above an LC compensation plate.

13. The transflective liquid crystal display device as claimed in claim 1, wherein the second LC film further includes a half-wave plate, and the half-wave plate is under an LC compensation plate.

14. A transflective liquid crystal display device, comprising:
a single-cell gap panel, and the lower surface of the single-cell gap panel having a reflective device;
an upper compensation plate that is composed of a half-wave plate and a quarter-wave plate, which is located at the top side of the single-cell gap panel;
a first polarizer, located at the top side of the upper compensation plate;
an LC film, equipped at the bottom side of the single-cell gap panel; and
a second polarizer, equipped at the bottom side of the LC film.

15. The transflective liquid crystal display device as claimed in claim 14, wherein the reflective device is a reflective plate with holes that forms a reflective area and a transmissive area.

16. The transflective liquid crystal display device as claimed in claim 14, wherein the reflective device is a metal transflective film.

17. The transflective liquid crystal display device as claimed in claim 14, wherein the LC film is one of a polymer LC film and an LC molecular layer.

18. The transflective liquid crystal display device as claimed in claim 14, wherein the twisted angle of the LC molecule of the single-cell gap panel is between 60°˜90°, and the retardation value of the single-cell gap panel is between 250 nm˜330 nm.

19. The transflective liquid crystal display device as claimed in claim 14, wherein the angle of the transmissive axis of the first polarizer is between 65°˜95°.

20. The transflective liquid crystal display device as claimed in claim 14, wherein the retardation value (Δnd) of the half-wave plate of the upper compensation plate is between 250˜290 nm, the slow axis angle is between 50°˜80°, the retardation value (Δnd) of the quarter-wave plate is between 140˜160 nm, and the slow axis angle is between 0°˜20°.

21. The transflective liquid crystal display device as claimed in claim 12, wherein the angle of the transmissive axis of the second polarizer is between 75°˜95°.

22. The transflective liquid crystal display device as claimed in claim 14, wherein the LC film includes an LC compensation plate and a half-wave plate under the LC compensation plate

23. The transflective liquid crystal display device as claimed in claim 14, wherein the LC film includes a LC compensation plate and a quarter-wave plate under the LC compensation plate.

24. A transflective liquid crystal display device, comprising:
a single-cell gap panel, and the lower surface of the single-cell gap panel having a reflective device;
a liquid crystal (LC) film, installed at the top side of the single-cell gap panel;
a first polarizer, equipped at the top side of the LC film;
a lower compensation plate that is composed of a half-wave plate and a quarter-wave plate, which is located at the bottom side of the single-cell gap panel; and
a second polarizer, equipped at the bottom side of the lower compensation plate.

25. The transflective liquid crystal display device as claimed in claim 24, wherein the reflective device is a reflective plate with holes that forms a reflective area and a transmissive area.

26. The transflective liquid crystal display device as claimed in claim 24, wherein the reflective device is a metal transfiective film.

27. The transflective liquid crystal display device as claimed in claim 24, wherein the LC film is one of a polymer LC film and a LC molecular layer.

28. The transflective liquid crystal display device as claimed in claim 24, wherein the twisted angle of the LC molecule of the single-cell gap panel is between 60°˜90°, and the retardation value of the single-cell gap panel is between 250 nm˜330 nm.

29. The transflective liquid crystal display device as claimed in claim 24, wherein the LC film includes an LC compensation plate and a quarter-wave plate under the LC compensation plate.

30. The transflective liquid crystal display device as claimed in claim 24, wherein the LC film includes an LC compensation plate and a half-wave plate above the LC compensation plate.
